(19) United States
(12) Patent Application Publication
(10) Pub. No.: US 2020/0048553 A1
(43) Pub. Date: Feb. 13, 2020

(54) LIQUID-CRYSTAL POLYESTER RESIN COMPOSITION

(71) Applicant: Sumitomo Chemical Company, Limited, Tokyo (JP)

(72) Inventors: Xinli HU, Shanghai (CN); Tomoyuki HARA, Tokyo (JP)

(21) Appl. No.: 16/344,682

(22) PCT Filed: Oct. 25, 2017
(86) PCT No.: PCT/JP2017/038529

§ 371 Date: Apr. 24, 2019

(30) Foreign Application Priority Data
Oct. 27, 2016 (JP) 2016-210790

(51) Int. Cl. C09K 19/38; C08L 67/04; B29B 7/06; B29C 45/00; C08K 5/20

(52) U.S. Cl. CPC C09K 19/38; C08L 67/04; B29K 2067/00; B29C 45/0001; C08K 5/20; B29B 7/06

(57) ABSTRACT

A liquid crystalline polyester resin composition is described, which includes a liquid crystalline polyester; and an amide compound including the following structural units (I) to (III), and having a melting point of ≥100° C. and a volume average particle diameter of ≥5 μm and ≤50 μm, wherein a content of the amide compound is ≥0.005 parts by mass and ≤0.1 parts by mass with respect to 100 parts by mass of a content of the liquid crystalline polyester,
structural unit (I): CH₃—X—CO—,
X represents an aliphatic hydrocarbon group having ≥10 carbon atoms or a hydroxy hydrocarbon group in which one or more hydrogen atoms of an aliphatic hydrocarbon group are substituted with a hydroxy group;
structural unit (II): —HN—Y—NH—,
Y represents a hydrocarbon group having ≥2 carbon atoms;
structural unit (III): —OC—Z—CO—,
Z represents an aliphatic hydrocarbon group having ≥4 carbon atoms, an alicyclic hydrocarbon group, or an aromatic hydrocarbon group.

### TECHNICAL FIELD

The present invention relates to a liquid crystalline polyester resin composition.

Priority is claimed on Japanese Patent Application No. 2016-210790, filed Oct. 27, 2016, the content of which is incorporated herein by reference.

### BACKGROUND ART

Liquid crystalline polyesters are generally called molten liquid crystalline (thermotropic liquid crystalline) polymers, extremely excellent in melt fluidity because of their specific behavior, and have a heat distortion resistance of 300° C. or more, depending on the structure. Liquid crystalline polyesters are used for molded articles in applications such as electronic components, OA, AV components, heat resistant tableware and the like, by taking advantage of such characteristics.

As a molding method for obtaining the above molded articles, an injection molding method is generally employed, in the injection molding method, a liquid crystalline polyester resin composition obtained by blending a liquid crystalline polyester with other components as necessary is usually used. Further, it is necessary in the injection molding method that: in an injection unit of an injection molding machine, the time required for measuring a melt of the aforementioned resin composition (that is, the plasticizing time of the aforementioned resin composition) is stabilized and the fluctuation is suppressed; and the aforementioned plasticizing time is shorter than the time required for cooling a molded article (cooling time of the molded article) obtained in a die unit of the injection molding machine.

However, in the liquid crystalline polyester resin composition, the plasticizing time tends to fluctuate without being stabilized, which may be longer than the cooling time. In this case, it is difficult to carry out molding in a fixed cycle, and the productivity of the molded article decreases in some cases.

In order to suppress such fluctuation in the plasticizing time of the liquid crystalline polyester resin composition, the use of a liquid crystalline polyester resin mixture in which polyamide compounds are mixed (Patent Document 1), the use of a liquid crystalline polyester resin mixture in which a phosphorus compound having a trivalent phosphorus atom and an amide compound are mixed (Patent Document 2), and a tablet containing 0.1 to 10 pans by weight of a carboxylic acid amide-based substance obtained by reacting a higher aliphatic monocarboxylic acid, a polybasic acid and a diamine with respect to a total amount of 100 parts by weight of a thermoplastic resin and a filler (Patent Document 3) are disclosed respectively.

### CITATION LIST

### Patent Documents

[Patent Document 1] Japanese Unexamined Patent Application, First Publication No. 2004-182748

[Patent Document 2] Japanese Unexamined Patent Application, First Publication No. 2007-308619

[Patent Document 3] Japanese Unexamined Patent Application, First Publication No. 2004-1487

### SUMMARY OF INVENTION

### Technical Problem

However, even if the resin mixtures disclosed in Patent Documents 1 to 3 are used, the stability of the plasticizing time at the time of molding is still insufficient, and, in an effort to improve this, when polyamide compounds or a phosphorus compound having a trivalent phosphorus atom and an amide compound are mixed in large quantities, there is a problem that the amide compounds fall off from pellets and are mistaken as foreign substances. Furthermore, according to the method of Patent Document 3, it is necessary to prepare a tablet, and there is a problem that the productivity decreases.

The present invention has been made in view of the above circumstances, with an object of providing a liquid crystalline polyester resin composition whose, plasticizing time at the time of molding is stable and which can stably perform a molding process, and a molded article obtained from the liquid crystalline polyester resin composition.

### Solution to Problem

In order to solve the above problems, the present invention includes the following aspects.

[1]. A liquid crystalline polyester resin composition including: a liquid crystalline polyester; and

an amide compound including the following structural units (I) to (III), and having a melting point of 100° C. or higher and a volume average particle diameter of 5 μm or more and 50 μm or less.

wherein a content of the aforementioned amide compound is 0.005 parts by mass or more and less than 0.1 parts by mass with respect to 100 parts by mass of a content of the aforementioned liquid crystalline polyester,

structural unit (I): CH₃—X—CO—

(X represents an aliphatic hydrocarbon group having 10 or more carbon atoms or a hydroxy hydrocarbon group in which one or more hydrogen atoms of an aliphatic hydrocarbon group are substituted with a hydroxy group)

structural unit (II): —HN—Y—NH—

(Y represents a hydrocarbon group having 2 or more carbon atoms)

structural unit (III): —OC—Z—CO—

(Z represents an aliphatic hydrocarbon group having 4 or more carbon atoms, an alicyclic hydrocarbon group, or an aromatic hydrocarbon group.)

[2]. The liquid crystalline polyester resin composition according to [1], wherein the structural unit (I) in the aforementioned amide compound is a structural unit represented by the following formula (I)′,

CH₃—(CH₂)ₗ—CO— (I)′:

(l represents an integer of 10 or more.)

[3]. The liquid crystalline polyester resin composition according to [1] or [2], wherein the structural unit (II) in the aforementioned amide compound is a structural unit represented by the following formula (II)′,

—HN—(CH₂)ₘ—NH— (II)′:

(m represents an integer of 2 to 12.)

[4]. The liquid crystalline polyester resin composition according to any one of [1] to [3], wherein the structural unit (III) in the aforementioned amide compound is a structural unit represented by the following formula (III)′,

—OC—(CH₂)ₙ—CO— (III)′:

(n represents an integer of 4 to 12.)

[5]. The liquid crystalline polyester resin composition according to any one of [1] to [4], wherein a content of the aforementioned amide compound is 0.02 parts by mass or more and 0.05 parts by mass or less with respect to 100 parts by mass of a content of the liquid crystalline polyester.

[6]. The liquid crystalline, polyester resin composition according to any one of [1] to [5], wherein the aforementioned amide compound includes 1 to 30 mol % of the structural unit (III) with respect to a total amount of the structural unit (I), the structural unit (II), and the structural unit (III).

[7]. The liquid crystalline polyester resin composition according to any one of [1] to [6], wherein the aforementioned liquid crystalline polyester includes a repeating unit derived from an aromatic hydroxycarboxylic acid, a repeating unit derived from an aromatic dicarboxylic acid, and a repeating unit derived from an aromatic diol, an aromatic hydroxyamine or an aromatic diamine.

[8]. A liquid crystalline polyester pellet wherein at least a part of a surface of a pellet containing a liquid crystalline polyester is coated with an amide compound.

the aforementioned amide compound includes the following structural units (I) to (III), and has a melting point of 100° C. or higher and a volume average particle diameter of 5 μm or more and 50 μm or less; and

a content of the aforementioned amide compound is 0.005 parts by mass or more and less than 0.1 parts by mass with respect to 100 parts by mass of a content of the aforementioned liquid crystalline polyester,

structural unit (I): CH₃—X—CO—

(X represents an aliphatic hydrocarbon group having 10 or more carbon atoms or a hydroxy hydrocarbon group in which one or more hydrogen atoms of an aliphatic hydrocarbon group are substituted with a hydroxy group)

structural unit (II): —HN—Y—NH—

(Y represents a hydrocarbon group having 2 or more carbon atoms)

structural unit (III): —OC—Z—CO—

(Z represents an aliphatic hydrocarbon group having 4 or more carbon atoms, an alicyclic hydrocarbon group, or an aromatic hydrocarbon group.)

[9]. An injection molded article formed from the liquid crystalline polyester resin composition according to any one of [1] to [7], or the liquid crystalline polyester pellet according to [8].

[10]. A method for producing a liquid crystalline polyester resin composition, the method including mixing a pellet containing a liquid crystalline polyester and an amide compound including the following structural units (I) to (III) and having a melting point of 100° C. or higher and a volume average particle diameter of 5 μm or more and 50 μm or less, so that a mixing amount of the aforementioned amide, compound is 0.005 parts by mass or more, and less than 0.1 parts by mass, when a mixing amount of the aforementioned liquid crystalline polyester is 100 parts by mass,

structural unit (I): CH₃—X—CO—

(X represents an aliphatic hydrocarbon group having 10 or more carbon atoms or a hydroxy hydrocarbon group in which one or more hydrogen atoms of an aliphatic hydrocarbon group are substituted with a hydroxy group)

structural unit (II): —HN—Y—NH—

(Y represents a hydrocarbon group having 2 or more carbon atoms)

structural unit (III): —OC—Z—CO—

(Z represents an aliphatic hydrocarbon group having 4 or more carbon atoms, an alicyclic hydrocarbon group, or an aromatic hydrocarbon group.)

[11]. An amide compound including the following structural units (I) to (III), and having a melting point of 100° C. or higher and a volume average particle diameter of 5 μm or more and 50 μm or less,

structural unit (I): CH₃—X—CO—

(X represents an aliphatic hydrocarbon group having 10 or more carbon atoms or a hydroxy hydrocarbon group in which one or more hydrogen atoms of an aliphatic hydrocarbon group are substituted with a hydroxy group)

structural unit (II): —HN—Y—NH—

(Y represents a hydrocarbon group having 2 or more carbon atoms)

structural unit (III): —OC—Z—CO—

(Z represents an aliphatic hydrocarbon group having 4 or more carbon atoms, an alicyclic hydrocarbon group, or an aromatic hydrocarbon group.)

### Advantageous Effects of Invention

According to the present invention, there are provided a liquid crystalline polyester resin composition whose plasticizing time at the time of molding is stable and which can stably perform a molding process, and a molded article obtained from the liquid crystalline polyester resin composition.

### DESCRIPTION OF EMBODIMENTS

### <Liquid Crystalline Polyester Resin Composition>

A liquid crystalline polyester resin composition of the present invention is a liquid crystalline polyester resin composition including a liquid crystalline polyester and an amide compound which is a compound having the following structural units (I) to (II) as structural units and having a melting point of 100° C. or higher, wherein a volume average particle diameter of the aforementioned amide compound is 5 μm or more and 50 μm or less and a content of the aforementioned amide compound is 0.005 parts by mass or more and less than 0.1 parts by mass with respect to 100 parts by mass of a content of the aforementioned liquid crystalline polyester,

structural unit (I): CH₃—X—CO—

(X represents an aliphatic hydrocarbon group having 10 or more carbon atoms or a hydroxy hydrocarbon group in which one or more hydrogen atoms of an aliphatic hydrocarbon group are substituted with a hydroxy group)

structural unit (II): —HN—Y—NH—

(Y represents a hydrocarbon group having 2 or more carbon atoms)

structural unit (III): —OC—Z—CO—

(Z represents an aliphatic hydrocarbon group having 4 or more carbon atoms, an alicyclic hydrocarbon group, or an aromatic hydrocarbon group.)

That is, one aspect of the liquid crystalline polyester resin composition of the present invention is,

a liquid crystalline polyester resin composition including: a liquid crystalline polyester; and an amide compound having the above structural units (I) to (III), and having a melting point of 100° C. or higher and a volume average particle diameter of 5 μm or more and 50 μm or less; wherein

a content of the aforementioned amide compound is 0.005 parts by mass or more and less than 0.1 parts by mass with respect to 100 parts by mass of a content of the aforementioned liquid crystalline polyester.

Since the aforementioned liquid crystalline polyester resin composition uses a liquid crystalline polyester and a specific amide compound in combination, and furthermore, the amount of the aforementioned amide compound to be used is in a specific range, as described later, the plasticizing time at the time of molding such as injection molding is stabilized, and the molding process can be stably performed.

Hereinafter, the components contained in the liquid crystalline polyester resin composition will be described.

### (Liquid Crystalline Polyester)

The liquid crystalline polyester is a polyester exhibiting liquid crystallinity in a molten state, and is preferably one that melts at a temperature of 450° C. or less (for example, 250° C. or more and 450° C. or less). It should be noted that the liquid crystalline polyester may be a liquid crystalline polyester amide, a liquid crystalline polyester ether, a liquid crystalline polyester carbonate, or a liquid crystalline polyester imide. The liquid crystalline polyester is preferably a wholly aromatic liquid crystalline polyester using only an aromatic compound as a raw material monomer.

Typical examples of the liquid crystalline polyester include a liquid crystalline polyester obtained by polycondensation of an aromatic hydroxycarboxylic acid, an aromatic dicarboxylic acid, and at least one compound selected from the group consisting of an aromatic diol, an aromatic hydroxyamine and an aromatic diamine; a liquid crystalline polyester in which a plurality of types of aromatic hydroxycarboxylic acids are polymerized; a liquid crystalline polyester in which an aromatic dicarboxylic acid and at least one compound selected from the group consisting of an aromatic diol, an aromatic hydroxyamine and an aromatic diamine are polymerized; and a liquid crystalline polyester in which a polyester such as polyethylene terephthalate and an aromatic hydroxycarboxylic acid are polymerized. Here, the aromatic hydroxycarboxylic acid, the aromatic dicarboxylic acid, the aromatic diol, the aromatic hydroxyamine and the aromatic diamine may be each independently replaced partially or entirely with a polymerizable derivative thereof.

Examples of the polymerizable derivative of a compound having a carboxy group, such as an aromatic hydroxycarboxylic acid and an aromatic dicarboxylic acid, include a derivative (also referred to as an ester) obtained by converting a carboxy group into an alkoxycarbonyl group or an aryloxycarbonyl group, a derivative (also referred to as an acid halide) obtained by converting a carboxy group into a haloformyl group, and a derivative (also referred to as an acid anhydride) obtained by converting a carboxy group into an acyloxycarbonyl group. Examples of the polymerizable derivative of a compound having a hydroxy group, such as an aromatic hydroxycarboxylic acid, an aromatic diol and an aromatic hydroxyamine, include a derivative (also referred to as an acylated product) obtained by acylating a hydroxy group and converting it into an acyloxyl group. Examples of the polymerizable derivative of a compound having an amino group, such as an aromatic hydroxyamine and an aromatic diamine, include a derivative (also referred to as an acylated product) obtained by acylating an amino group and converting it into an acylamino group.

The liquid crystalline polyester preferably has a repeating unit represented by a formula (1) (hereinafter may be referred to as “repeating unit (1)” in some cases), and more preferably has the repeating unit (1), a repeating unit represented by a formula (2) (hereinafter may be referred to as “repeating unit (2)” in some cases) and a repeating unit represented by a formula (3) thereinafter may be referred to as “repeating unit (3)” in some cases).

—O—Ar¹—CO— (1)

—CO—Ar²—CO— (2)

—X—Ar³—Y— (3)

[In the formulas (1) to (3), Ar¹ represents a phenylene group, a naphthylene group or a biphenylylene group; each of Ar² and Ar³ independently represents a phenylene group, a naphthylene group, a biphenylylene group or a group represented by a formula (4); each of X and Y independently represents an oxygen atom or an imino group (—NH—); and at least one hydrogen atom in the group represented by Ar¹, Ar² or Ar³ may be each independently substituted with a halogen atom, an alkyl group having 1 to 10 carbon atoms or an aryl group having 6 to 20 carbon atoms.]

—Ar⁴—Z—Ar⁵— (4)

[In the formula (4), Ar⁴ and Ar⁵ each independently represent a phenylene group or a naphthylene group; and Z represents an oxygen atom, a sulfur atom, a carbonyl group, a sulfonyl group or an alkylidene group having 1 to 10 carbon atoms.]

Examples of the halogen atom which can be substituted with a hydrogen atom include a fluorine atom, a chlorine atom, a bromine atom and an iodine atom.

Examples of the alkyl group having 1 to 10 carbon atoms which can be substituted with a hydrogen atom include a methyl group, an ethyl group, an n-propyl group, an isopropyl group, an n-butyl group, an isobutyl group, a sec-butyl group, a tert-butyl group, an n-hexyl group, a 2-ethylhexyl group, an n-octyl group and an n-decyl group.

Examples of the aryl group having 6 to 20 carbon atoms which can be substituted with a hydrogen atom include a monocyclic aromatic group such as a phenyl group, n o-tolyl group, an in-tolyl group and a p, tolyl group, a condensed aromatic group such as a 1-napthyl group and a 2-naphthyl group, and the like.

When at least one hydrogen atom in the group represented by Ar¹, Ar² or Ar³ is substituted with these groups, the number of substitutions is preferably, each independently, 1 or 2, and more preferably 1 for each of the groups represented by Ar¹, Ar² or Ar³.

Examples of the alkylidene group having 1 to 10 carbon atoms include a methylene group, an ethylidene group, an isopropylidene group, an n-butylidene group, and a 2-ethylhexylidene group.

The repeating unit (1) is a repeating unit derived from a predetermined aromatic hydroxycarboxylic acid.

At the repeating unit (1), a repeating unit in which Ar¹ is a 1,4-phenylene group (for example, a repeating unit derived from p-hydroxybenzoic acid) and a repeating unit in which Ar¹ is a 2,6-naphthylene group (for example, a repeating unit derived from 6-hydroxy-2-naphthoic acid) are preferred.

The repeating unit (2) is a repeating unit derived from a predetermined aromatic dicarboxylic acid.

As the repeating unit (2), a repeating unit in which Ar² is a 1,4-phenylene group (for example, a repeating unit derived from terephthalic acid), a repeating unit in which Ar² is a 1,3-phenylene group (for example, a repeating unit derived from isophthalic acid), a repeating unit in which Ar² is a 2,6-naphthylene group (for example, a repeating unit derived from 2,6-naphthalene dicarboxylic acid), and a repeating unit in which Ar² is a diphenyl ether-4,4′-diyl group (for example, a repeating unit derived from diphenyl ether-4,4′-dicarboxylic acid) are preferable.

The repeating unit (3) is a repeating unit derived from a predetermined aromatic diol, aromatic hydroxyamine or aromatic diamine.

As the repeating unit (3), a repeating unit in which Ar³ is a 1,4-phenylene group (for example, a repeating unit, derived from hydroquinone, p-aminophenol or p-phenylenediamine) and a repeating unit in which Ar³ is a 4,4′-biphenylylene group (for example, a repeating unit, derived from 4,4′-dihydroxybiphenyl, 4-amino-4′-hydroxybiphenyl or 4,4′-diaminobiphenyl) are preferable.

It should be noted that in the present specification, the expression “derived” means that the chemical structure is changed due to polymerization of raw material monomers, while no other structural change occurs.

The content rate of the repeating unit (1) in the liquid crystalline polyester is preferably 30 mol % or more, more preferably from 30 to 80 mol %, still more preferably from 40 to 70 mol % and particularly preferably from 45 to 65 mol %, with respect to the total amount (number of moles) of all the repeating units constituting the liquid crystalline polyester (that is, a value obtained by dividing the mass of each repeating unit constituting the liquid crystalline polyester by the formula weight of each repeating unit, determining the equivalents (mol) of the amounts of substances of each repeating unit and summing them up).

The higher the content rate of the repeating unit (1) in the liquid crystalline polyester, the easier the melt fluidity, heat resistance and strength/rigidity of the liquid crystalline polyester are improved, but if it is too high, for example in excess of 80 mol %, the melt temperature and melt viscosity of the liquid crystalline polyester tend to be high, and the temperature required for molding tends to be high.

That is, when the content of the repeating unit (1) is within the above range, the melt fluidity, heat resistance and strength/rigidity are easily improved, the melt temperature and melt viscosity of the liquid crystalline polyester do not become too high, and the balance between the heat resistance, the strength/frigidity and the molding processability becomes satisfactory.

The content rate of the repeating unit (2) in the liquid crystalline polyester is preferably 35 mol % or less, more preferably from 10 to 35 mol, still more preferably from 15 to 30 mol %, and particularly preferably from 17.5 to 27.5 mol % with respect to the total amount of all the repeating units constituting the liquid crystalline polyester.

The content rate of the repeating unit (3) in the liquid crystalline polyester is preferably 35 mol % or less, more preferably from 10 to 35 mol %, still more preferably from 15 to 30 mol %, and particularly preferably from 17.5 to 27.5 mol % with respect to the total amount of all the repeating units constituting the liquid crystalline polyester.

In the liquid crystalline polyester, the ratio of the content of the repeating unit (2) to the content of the repeating unit (3) represented by the formula: [content of the repeating unit (2)]/[content of the repeating unit (3)] (mol/mol) is preferably from 0.9/1 to 1/0.9, more preferably from 0.95/1 to 1/0.95, and still more preferably from 0.98/1 to 1/0.98.

It should be noted that the liquid crystalline polyester may have only one type of repeating units (1) to (3) or may have two or more types thereof, independently of each other. Further, the liquid crystalline polyester may contain one or more repeating units other than the repeating units (1) to (3), but the content thereof is preferably from 0 to 10 mol %, and more preferably from 0 to 0.5 mol %, with respect to the total amount of all the repeating units constituting the liquid crystalline polyester.

Since the melt viscosity of the liquid crystalline polyester is likely to be lowered (the melt viscosity does not become too high), the liquid crystalline polyester preferably includes a repeating unit in which X and Y each represent an oxygen atom, that is, includes a repeating unit derived from a predetermined aromatic diol, as the repeating unit (3), and more preferably includes only a repeating unit in which X and Y each represent an oxygen atom as the repeating units (3).

However, the total amount of the repeating unit (1), the repeating unit (2) and the repeating unit (3) does not exceed 100 mol %.

Among the above the liquid crystalline polyester is preferably composed only of the repeating unit (1), the repeating unit (2) and the repeating unit (3). Further, it is more preferable that such a liquid crystalline polyester has, with respect to the total amount of all the constituting repeating units, 30 to 80 mol % of the repeating unit (1), 10 to 35 mol % of the repeating unit (2) and 10 to 35 mol % of the repeating unit (3), and the sum thereof is 100 mol %.

The liquid crystalline polyester is preferably produced by melt polymerization of a raw material monomer corresponding to the repeating unit constituting the liquid crystalline polyester and solid phase polymerization of the obtained polymer (hereinafter sometimes referred to as “prepolymer”). As a result, a high molecular weight liquid crystalline polyester having high heat resistance, strength and rigidity can be produced with favorable operability. The melt polymerization may be carried out in the presence of a catalyst. Examples of the catalyst include metal compounds such as magnesium acetate, stannous acetate, tetrabutyl titanate, lead acetate, sodium acetate, potassium acetate and antimony trioxide, and nitrogen-containing heterocyclic compounds such as 4-(dimethylamino) pyridine and 1-methylimidazole, and preferred examples thereof include nitrogen-containing heterocyclic compounds.

The flow starting temperature of the liquid crystalline polyester is preferably 270° C. or higher, more preferably 270° C. or higher and 400° C. or lower, and still more preferably 280° C. or higher and 380° C. or lower. The higher the flow starting temperature of the liquid crystalline polyester, the easier it is to improve the heat resistance and the strength/rigidity. However, if it is too high, a high temperature is required for melting, and thermal degradation tends to occur during molding, and the viscosity at the time of melting increases to lower the fluidity.

That is, when the flow starting temperature of the liquid crystalline polyester is within the above range, the heat resistance and strength/rigidity are easily improved and the melt temperature does not become too high, so that the thermal degradation during molding and the decrease in fluidity can be prevented.

It should be noted that the “flow starting temperature” is also referred to as flow temperature or fluidity temperature and serves as an indicator of the molecular weight of a liquid crystalline polyester, which is a temperature where a viscosity of 4,800 Pa·s (48,000 poise) is exhibited when a liquid crystalline polyester is melted and extruded from a nozzle having an inner diameter of 1 mm and a length of 10 mm, while raising the temperature at a rate of 4° C./min under a load of 9.8 MPa using a capillary rheometer (see “Liquid Crystalline Polymer—Synthesis, Molding, and Application—” edited by Naoyuki Koide, p. 95, CMC Publishing Co., Ltd., published on Jun. 5, 1987).

A single type of the liquid crystalline polyester may be used alone, or two or more types thereof may be used in combination.

The content of the liquid crystalline polyester is preferably from 45 to 80% by mass, more preferably from 50 to 70% by mass, and particularly preferably from 55 to 65% by mass, with respect to the total mass of the liquid crystalline polyester resin composition.

### (Amide Compound)

The amide compound is a carboxylic acid amide compound having a structural unit (I), a structural unit (II) and a structural unit (III), and having a melting point of 100° C. or higher.

In one aspect, the amide compound is a compound having the structural unit (I), the structural unit (II) and the structural unit (III), which is bonded to form an amide bond.

In another aspect, the amide compound is a compound having the structural unit (I), the structural unit (II) and the structural unit (III), and in which the structural unit (I) is bonded to the terminal.

Structural unit (I): CH₃—X—CO—

(X represents an aliphatic hydrocarbon group having 10 or more carbon atoms or a hydroxy hydrocarbon group in which one or more hydrogen atoms of an aliphatic hydrocarbon group are substituted with a hydroxy group)

Structural unit (II): —HN—Y—NH—

(Y represents a hydrocarbon group having 2 or more carbon atoms)

Structural unit (III): —OC—Z—CO—

(Z represents an aliphatic hydrocarbon group having 4 or more carbon atoms, an alicyclic hydrocarbon group, or an aromatic hydrocarbon group.)

In the structural unit (I), when X is the hydroxy hydrocarbon group, the number of hydroxy groups in X is preferably one.

As the compound that leads to the structural unit (I), aliphatic monocarboxylic acids and hydroxycarboxylic acids having 12 or more carbon atoms are preferable, and specific examples thereof include lauric acid, myristic acid, palmitic acid, stearic acid, oleic acid, linoleic acid, behenic acid, montanic acid and 12-hydroxystearic acid.

The upper limit value of the number of carbon atoms of the structural unit (I) is not particularly limited, but the number of carbon atoms is preferably 28 or less. That is, the number of carbon atoms of the structural unit (I) is preferably 12 or more and 28 or less. The number of carbon atoms of X in the structural unit (I) is preferably front 10 to 26.

The structural unit (I) is preferably an aliphatic monocarboxylic acid having 12 or more carbon atoms, and more preferably a structural unit represented by the following formula (I)′.

CH₃—(CH₂)ₗ—CO— (I)′:

(l represents an integer of 10 or more.)

In the above formula (I)′, l is preferably from 10 to 26.

As the compound that leads to the structural unit (I)′, lauric acid, myristic acid, palmitic acid, stearic acid, behenic acid and montanic acid are preferable.

In the structural unit (II), Y may be any of an aliphatic hydrocarbon group, an alicyclic hydrocarbon group and an aromatic hydrocarbon group.

The number of carbon atoms in the structural unit (I) is 2 or more, and specific examples of the compound that leads to the structural unit (II) include ethylenediamine, 1,3-diaminopropane, 1,4-diaminobutane, pentamethylenediamine, hexamethylenediamine, nonamethylenediamine, undecamethylenediamine, dodecamethylenediamine, metaxylylenediamine, paraxylylenediamine, tolylenediamine, phenylenediamine and isophoronediamine.

The upper limit value of the number of carbon atoms of the structural unit (II) is not particularly limited, but the number of carbon atoms is preferably 2 or more and 12 or less.

That is, the number of carbon atoms of Y is preferably 2 or more and 12 or less.

The structural unit (II) is preferably a structural unit represented by the following formula (II)′.

—HN—(CH₂)ₘ—NH— (II)′:

(m represents an integer of 2 to 12.)

As the compound tat leads to the structural unit (II)′, ethylenediamine, 1,3-diaminopropane, hexamethylenediamine, undecamethylenediamine and dodecamethylenediamine are preferable.

The number of carbon atoms in the structural unit (III) is 6 or more, and specific examples of the compound that leads to the structural unit (III) include aliphatic dicarboxylic acids such as adipic acid, sebacic acid, pimelic acid and azelaic acid; aromatic dicarboxylic acids such as phthalic acid, terephthalic acid and isophthalic acid; and alicyclic dicarboxylic acids such as cyclohexanedicarboxylic acid and cyclohexylsuccinic acid.

The upper limit value of the number of carbon atoms of the structural unit (III) is not particularly limited, but the number of carbon atoms is preferably 14 or less. That is, the number of carbon atoms of the structural unit (III) is preferably 6 or more and 14 or less.

The number of carbon atoms of Z in the structural unit (III) is preferably from 4 to 12.

The structural unit (III) is preferably a structural unit represented by the following formula (III)′.

—OC—(CH₂)ₙ—CO— (III)′:

(n represents an integer of 4 to 12.)

As the compound that leads to the structural unit (III)′, adipic acid, sebacic acid, pimelic acid and azelaic acid are preferable.

The amide compound preferably has 1 to 30 mol %, more preferably has 3 to 25 mol % and still more preferably has 3 to 20 mol % of the structural unit (III), with respect to the total amount of the structural unit (I), the structural unit (II) and the structural unit (III).

In another aspect, the amide compound preferably has 30 to 60 mol % of the structural unit (I) with respect to the total amount of the structural unit (I), the structural unit (II) and the structural unit (III).

In yet another aspect, the amide compound preferably has 30 to 50 mol % of the structural unit (II) with respect to the total amount of the structural unit (I), the structural unit (II) and the structural unit (III).

The amide compound is preferably in a powder form or a granular form.

The volume average particle diameter of the amide compound is 5 μm or more and 50 μm or less, and preferably 5 μm or more and 35 μm or less. In another aspect, the volume average particle diameter of the amide compound may be 9 μm or more and 46 μm or less, and may be 9 pan or more and 28 μm or less.

When the volume average particle diameter of the amide compound falls within the above range, the amide compound is easily blended since a secondary aggregation is hardly formed, and furthermore, the amide compound easily adheres to the surface of the resin composition to cover the surface, while hardly detaching from the resin composition, which is preferable.

Here, the “volume average particle diameter of the amide compound” can be measured by a laser diffraction scattering method using, for example, a laser diffraction/scattering type particle size distribution measuring apparatus manufactured by HORIBA, Ltd.

The melting point of the amide compound is 100° C. or more, preferably 100° C. or more and 300° C. or less, and more preferably 200° C. or more and 300° C. or less.

It should be noted that the “melting point of the amide compound” can be obtained from the endothermic peak temperature observed when the amide compound is heated from room temperature to 400° C. under a condition of temperature increase of 20° C./min by differential calorimetry.

The above amide compound, that is, the amide compound having the structural units (I) to (III) and having a melting point of 100° C. or more and a volume average particle diameter of 5 μm or more and 50 μm or less is a novel material.

In addition to the structural unit (I), the structural unit (II) and the structural unit (III), the amide compound may further include other structural units that do not correspond to any of these structural units.

The other structural units are not particularly limited as long as the effects of the present invention are not impaired.

As the other structural unit, for example, a monofunctional compound reactive with the terminal amino group or the terminal carboxyl group of the polyamide may be added in a small amount as a molecular weight regulator.

As the molecular weight regulator, for example, monocarboxylic acids such as acetic acid, propionic acid, butyric acid, valeric acid, caproic acid, caprylic acid, lauric acid, tridecylic acid, myristic acid, palmitic acid, stearic acid, pivalic acid, cyclohexanecarboxylic acid, benzoic acid, toluic acid and naphthalenecarboxylic acid may be added. Further, acid anhydrides such as monoamines and phthalic anhydride, monoisocyanates, monoacid halide compounds, monoester compounds and monoalcohol compounds may be used.

The amide compound preferably has 80 mol % or more, more preferably 90 mol % or more, still more preferably 95 mol % or more, and may even have 100 mol % of the structural unit (I), the structural unit (I) and the structural unit (III) in total, with respect to the total amount (100 mol %) of all the structural units constituting the amide compound. In other words, the amide compound may have only the structural unit (I), the structural unit (II) and the structural unit (III) as structural units constituting the amide compound.

Any one of these amide compounds according to the present invention may be used alone, or two or more compounds may be used in combination.

The weight average molecular weight of the amide compound is preferably 700 or more and 5,000 or less, more preferably 1,000 or more and 4,000 or less, and still more preferably 1,000 or more and 3,000 or less.

When the weight average molecular weight of the amide compound is within the above range, the melting point can be easily adjusted to 100° C. or more and 300° C. or less.

The “weight average molecular weight” can be measured by get permeation chromatography (GPC).

GPC measurement can be carried out, for example, by using Shodex GPC SYSTEM-11 manufactured by Showa Denko K.K., hexafluorisopropanol (HFIP) as a solvent and dissolving 10 mg of a polyamide resin sample in 10 g of HFIP. The weight average molecular weight can be determined by using pMMA as a standard sample and using data processing software.

The amide compound can be obtained, for example, by reacting a compound that leads to the structural unit (I) or a derivative thereof capable of forming an amide bond, a compound that leads to the structural unit (II) or a derivative thereof capable of forming an amide bond, and a compound that leads to the structural unit (III) or a derivative thereof capable of funning an amide bond.

As the compound that leads to the structural unit (I), a carboxylic acid in which a hydroxy group is bonded to the carbon atom of the carbonyl group (—CO—) in the structural unit (I) (that is, a compound represented by the formula “CH₃—X—CO—OH” (wherein X is the same as defined above)) can be mentioned.

As the derivative of the compound (the above-mentioned carboxylic acid) that can form an amide bond and leads to the structural unit (I), for example, those obtained by convening the carboxy group (—CO—OH) in the carboxylic acid into an alkoxycarbonyl group or aryloxycarbonyl group (that is, ester), those obtained by converting a carboxy group into a haloformyl group (that is, acid halides), and those obtained by converting a carboxy group into an acyloxycarbonyl group (that is, acid anhydrides) can be mentioned.

As the compound that leads to the structural unit (II), diamines in which hydrogen atoms are bonded respectively to two nitrogen atoms in the structural unit ill) (that is, a compound represented by the formula “H₂N—Y—NH₂ (wherein Y is the sane as defined above”) can be mentioned.

As the derivative of the compound (the above-mentioned diamine) that can form an amide bond and leads to the structural unit (II), for example, those obtained by acylating the amino group (—NH₂) in the diamine and converting it into an acylamino group (that is, acylated products) can be mentioned.

As the compound that leads to the structural unit (III), dicarboxylic acids in which hydroxy groups are bonded respectively to the carbon atoms of two carbonyl groups (—CO—) in the structural unit (III) (that is, a compound represented by the formula “HO—OC—Z—CO—OH” (wherein Z is the same as defined above)) can be mentioned.

As the derivative of the compound (the above-mentioned dicarboxylic acid) that can form an amide bond and leads to the structural unit (III), for example, those obtained by converting the carboxy group (—CO—OH) in the carboxylic acid into an alkoxycarbonyl group or aryloxycarbonyl group (that is, esters), those obtained by converting a carboxy group into a haloformyl group (that is, acid halides), and those obtained by converting a carboxy group into an acyloxycarbonyl group (that is, acid anhydrides) can be mentioned.

The method for producing the amide compounds used in the present invention is not particularly limited, and they can be produced by a conventionally known method. One example is as follows. That is, for example, in the case of obtaining an amide compound by a reaction such as a dehydration reaction of a higher aliphatic monocarboxylic acid, a polybasic acid and a diamine, it is possible that the higher aliphatic monocarboxylic acid and the polybasic acid are heated and melted, followed by addition of the diamine thereto, and the dehydration reaction is carried out at 100° C. or more and 350° C. or less in an inert gas stream. The product obtained by such a dehydration reaction is usually a mixture of a product having structural units derived from a higher aliphatic monocarboxylic acid, a polybasic acid and a diamine, and a product having structural units derived from a higher aliphatic monocarboxylic acid and a diamine while having no structural unit derived from a polybasic acid. The production ratio of these products varies depending on the reaction conditions such as the charged molar ratio of each component at the time of the reaction. In the present invention, it is preferable to use the mixture in which the proportion of the product having structural units derived from a higher aliphatic monocarboxylic acid and a diamine and having no structural unit derived from a polybasic acid is preferably 50% by mass or less, and more preferably 10% by mass or more and 50% by mass or less, with respect to the total mass of all carboxylic acid amide-based substances. The mixture having such a composition can be obtained by adjusting the ratio of the higher aliphatic monocarboxylic acid, the polybasic acid and the diamine.

Examples of the amide compounds having the structural unit (I), the structural unit (II) and the structural unit (III) include commercially available products such as Light Amide WH-255 and Light Amide WH-215 (both manufactured by Kyoeisha Chemical Co., Ltd.).

In the liquid crystalline polyester resin composition, the content of the amide compound with respect to the content of 100 parts by mass of the liquid crystalline polyester is 0.005 pans by mass or more and less than 0.1 parts by mass, preferably 0.01 parts by mass or more and 0.08 parts by mass or less, and more preferably 0.02 parts by mass or more and 0.05 parts by mass or less. In another aspect, in the liquid crystalline polyester resin composition, the content of the amide compound with respect to the content of 100 parts by mass of the liquid crystalline polyester may be 0.007 parts by mass or more and 0.08 parts by mass or less, or may be 0.03 parts by mass or more and 0.04 parts by mass or less.

When the content of the amide compound falls within the above range, the plasticizing time during molding of the liquid crystalline polyester resin composition becomes more stable. When the content of the amide compound is less than 0.005 parts by mass, the stabilizing effect of the plasticizing time becomes insufficient. On the other band, when the content of the amide compound is 0.1 parts by mass or more, the amide compound is likely to fall off from the surface of an intermediate composition such as an intermediate composition pellet to be described later, so that the hopper of the molding machine tends to become dirty, and mechanical properties and the like are deteriorated. That is, when the content of the amide compound falls within the above range, the effect of stabilizing the plasticizing time is sufficient, the amide compound is unlikely to fall off front the surface of the intermediate composition such as the intermediate composition pellet to be described later, the hopper of the molding machine is unlikely to become dirty, and the mechanical properties and the like are hardly deteriorated.

### (Filler)

In addition to the liquid crystalline polyester and the amide compound, the liquid crystalline polyester resin composition of the present invention preferably further contains a filler.

The filler is not particularly limited, and may be a fibrous filler, a plate-like filler or a particulate filler, in addition, the filler may be an inorganic filler or an organic filler.

Examples of the fibrous inorganic filler include glass fibers; carbon fibers such as polyacrylonitrile (PAN)-based carbon fibers and pitch-based carbon fibers; ceramic fibers such as silica fibers alumina fibers and silica alumina fibers; and metal fibers such as stainless steel fibers. In addition, as examples of the fibrous inorganic filler, whiskers such as potassium titanate whisker, barium titanate whisker, wollastonite whisker, aluminum borate whisker, silicon nitride whisker and silicon carbide whisker can also be mentioned.

Examples of the glass fibers include those produced by various methods such as chopped strand glass fibers, milled strand glass fibers and the like.

Examples of the fibrous organic filler include polyester fibers and aramid fibers.

Among those described above, as the fibrous filler, chopped strand glass fibers and milled strand glass fibers are preferred.

Examples of the plate-like inorganic filler include talc, mica, graphite, wollastonite, glass flakes, barium sulfate and calcium carbonate. The mica may be muscovite, phlogopite, fluorophlogopite or tetrasilicon mica.

Among them, talc is preferable as the plate-like filler.

Examples of the particulate inorganic filler include silica, alumina, titanium oxide, boron nitride, silicon carbide and calcium carbonate.

A single type of the filler may be used alone, or two or more types thereof may be used in combination.

The filler is preferably one or more members selected from the group consisting of the fibrous fillers, the plate-like fillers and the particulate fillers, more preferably one or more members selected from the group consisting of the fibrous fillers and the plate-like fillers, and still more preferably one or more types of the fibrous fillers and one or more types of the plate-shaped fillers.

In another aspect, the filler is preferably at least one member selected from the group consisting of milled glass fibers, chopped strand glass fibers and talc.

In the liquid crystalline polyester resin composition, the content of the filler with respect to 100 parts by mass of the liquid crystalline polyester content is preferably 10 parts by mass or more and 150 pans by mass or less, more preferably 10 parts by mass or more and 130 parts by mass or less, still more preferably 25 pans by mass or more and 110 parts by mass or less, particularly preferably 40 parts by mass or more and 90 parts by mass or less, particularly preferably 55 parts by mass or more and 80 parts by mass or less, and extremely preferably 60 parts by mass or more and 70 parts by mass or less. When the content of the filler is in the above range, heat resistance and strength of the molded article tend to be improved, which is preferable.

### (Other Components)

The liquid crystalline polyester resin composition of the present invention may further contain components other than the liquid crystalline polyester, the amide compound and the filler.

The other components are not particularly limited and may be appropriately selected according to the purpose.

Examples of the other components include additives known in this field, resins other than the liquid crystalline polyesters (hereinafter sometimes referred to as “other resins”), and the like.

That is, in one aspect, the liquid crystalline polyester resin composition of the present invention contains one or more types selected from the group consisting of the liquid crystalline polyesters, the amide compounds, and, if required, the fillers and the other components.

Examples of the additives include antioxidants, thermal stabilizers, ultraviolet absorbers, antistatic agents, surfactants, flame retardants and colorants.

Examples of the other resins include thermoplastic resins such as polysulfones, polyethersulfones, polypropylenes, polyamides, polyesters other than liquid crystalline polyesters, polyphenylene sulfides, polyether ketones, polycarbonates, polyphenylene ethers and polyether imides; and thermosetting resins such ax phenol resins, epoxy resin, polyimide resins, and cyanate resins.

A single type of the other components may be used alone, or two or more types thereof may be used in combination.

In the case where the other components are contained, the content of the other components in the liquid crystalline polyester resin composition is not particularly limited a's long as the effects of the present invention are not impaired, but it is preferably 10% by mass or less, more preferably 5% by mass or less, still more preferably 3% by mass or less and particularly preferably 1% by mass or less, with respect to t e total mass of the liquid crystalline polyester resin composition. When the content of the other components is equal to or less than the above upper limit value, the plasticizing time during molding of the liquid crystalline polyester resin composition becomes more stable.

### <Method for Producing Liquid Crystalline Polyester Resin Composition>

The liquid crystalline polyester resin composition can be obtained, for example, by mixing the liquid crystalline polyester the amide compound, and if required, one or more members selected from the group consisting of the fillers and the other components at once or in an appropriate order.

In particular, the liquid crystalline polyester resin composition is preferably produced, for example, by melt-kneading the liquid crystalline polyester and, if required, one or more components other than the liquid crystalline polyester and the amide compound (for example, the fillers, the other components, and the like) to obtain an intermediate composition as a kneaded product, and then mixing the amide compound in a solid form with the intermediate composition.

The intermediate composition can be obtained, for example, by mixing the liquid crystalline polyester and, if necessary, the components other than the liquid crystalline polyester and the amide compound at once or in an appropriate order and melt-kneading the obtained mixture using an extruder or the like. The obtained intermediate composition (kneaded product) may be pulverized its necessary to be made into a powder form.

As the extruder, an extruder having a cylinder, at least one screw disposed in the cylinder, and at least one supply port provided in the cylinder is preferable, and an extruder further having at least one vent portion provided in the cylinder is more preferable.

The temperature at the time of melt-kneading is not particularly limited, but is preferably 200° C. or more and 400° C. or less, and more preferably 300° C. or more and 380° C. or less.

The intermediate composition may be in a form of pellet (also referred to as an intermediate composition pellet). That is, in one aspect, the liquid crystalline polyester resin composition of the present invention is a liquid crystalline polyester resin composition, wherein at least a part of the surface of a pellet containing a liquid crystalline polyester (that is, an intermediate composition pellet) is coated with an amide compound, the aforementioned amide compound includes the aforementioned structural units (I) to (III) and has a melting point of 100° C. or higher and a volume average particle diameter of 5 μm or more and 50 μm or less, and the content of the aforementioned amide compound is 0.005 parts by mass or more and less than 0.1 parts by mass with respect to 100 parts by mass of the content of the aforementioned liquid crystalline polyester.

The liquid crystalline polyester resin composition may be in a form of pellet (also referred to as liquid crystalline polyester pellet).

In the present specification, the phrase “at least a part of the surface of a pellet containing a liquid crystalline polyester is coated with an amide compound” means that an amide compound is present on at least a part of the surface of the pellet. The amide compound present on the surface of the pellet may be physically adhered to the surface or chemically adhered through a chemical bond. In particular, the amide compound is preferably physically adhered to the surface of the pellet.

Further, one aspect of the method for producing the liquid crystalline polyester resin composition is a production method including mixing a pellet (intermediate composition pellet) containing a liquid crystalline polyester and the aforementioned amide compound having the aforementioned structural units (I) to (III) and having a melting point of 100° C. or higher and a volume average particle diameter of 5 μm or more and 50 μm or less, so that a mixing amount of the aforementioned amide compound is 0.005 parts by mass or more and less than 0.1 pans by mass, when a mixing amount of the aforementioned liquid crystalline polyester is 100 parts by mass.

The aforementioned pellet (intermediate composition pellet) can be obtained, for example, by extruding the aforementioned kneaded product (intermediate composition) from an extruder or the like in a strand form and pelletizing with a cutter having a rotary blade in the above-described method for producing an intermediate composition. The pellet length is preferably from 1 to 5 mm and can be adjusted by the speed of the rotary blade. Process properties of pellet feed and the like are also favorable within this range.

The shape of the pellet (intermediate composition pellet) is not particularly limited and can be arbitrarily selected according to the purpose. Examples of preferable shapes of the pellet include spherical shapes, rectangular shapes, elliptical shapes, shapes that are somewhat deformed from precise ellipses, and cylindrical shapes, and an elliptical shape or a cylindrical shape is preferable.

With regard to the pellet (intermediate composition pellet), a length (long diameter) indicated by a straight line connecting the two furthest points on a cut surface of the pellet when cut at an arbitrary plane perpendicular to the longitudinal direction of the pellet is not particularly limited as long as the effects of the present invention are not impaired, but it is, for example, preferably 1 mm or more and 7 mm or less, and more preferably 2 mm or more and 5 mm or less. Further, a length (short diameter) indicated by a straight line connecting the two closest points on the cut surface of the pellet is not particularly limited as long as the effects of the present invention are not impaired. The short diameter is, for example, preferably 1 mm or more and 5 mm or less. However, in the pellet, the ratio of major axis to minor axis ((major axis)/(minor axis)) is preferably 1 or more and 4 or less. In the pellet whose cut section is not circular, the maximum width and the minimum width of the central portion of the cross section correspond to the long diameter and the short diameter, respectively. The long diameter and short diameter of the pellet can be adjusted by adjusting the diameter of the nozzle of an extruder or the like and adjusting the diameter of the strand.

It should be noted that the long diameter and short diameter in the pellet can be obtained through measurement using, for example, a caliper or the like.

The temperature of the intermediate composition when mixing the solid amide compound is preferably 20° C. or more and 200° C. or less, and more preferably room temperature or more and 180° C. or less. When it is within such a temperature range, dissolution of the mixed amide compound can be prevented and detachment of the amide compound from the pellet can be suppressed, which is preferable.

In the liquid crystalline polyester resin composition, the amide compound may be present, for example, both in the interior and on the surface of the intermediate composition such as the pellet, may be present only on the surface of the intermediate composition, or may be present only in the interior of the intermediate composition. However, since the plasticizing time during molding of the liquid crystalline polyester resin composition is more stabilized, it is preferable that the amide compound is present on at least a part of the surface of the intermediate composition.

It should be noted that the amide compound is preferably present on at least a part of the surface of the intermediate composition, more preferably present in an amount of more than 0% and 10% or less, still more preferably present in an amount of more than 0% and 5% or less, and particularly preferably present in an amount of more than 0% and 1% or less, with respect to the entire surface of the intermediate composition.

Further, the amide compound is preferably dispersed in the intermediate composition.

Preferred examples of the liquid crystalline polyester resin composition as described above include a liquid crystalline polyester resin composition in which at least a part of the surface of the intermediate composition such as the pellet is coated with the amide compound. Such a liquid crystalline polyester resin composition is excellent in that the amide compound is more likely to act and the effects of the present invention can be obtained more remarkably.

A liquid crystalline polyester resin composition in which at least a part of the surface of the pellet (intermediate composition pellet) is coated with the amide compound can be produced, for example, by mixing the intermediate composition pelletized by the above-described method and the amide compound. The method of mixing the pellet and the amide compound is not particularly limited as long as it is a method capable of coating the surface of the pellet with the amide compound. Examples of a method capable of coating at least a part of the surface of the pellet with the amide compound with high uniformity include a method using a known stirring device such as a tumbler mixer or a Henschel mixer.

### <Molded Article>

The molded article according to one embodiment of the present invention is formed from the above-described liquid crystalline polyester resin composition or liquid crystalline polyester pellet of the present invention. More specifically, the molded article can be produced, for example, by molding using a melt molding method such as an injection molding method; an extrusion molding method such as a T-die method and an inflation method; a compression molding method; a low molding method; a vacuum molding method; and a press molding method. In particular, the molded article of the present invention is preferably an injection molded article.

At the time of molding, other components may be further blended in addition to the liquid crystalline polyester resin composition.

The other components at the time of molding are not particularly limited as long as the effects of the present invention are not impaired. One of the other components at the time of molding may be used alone, or two or more components may be used in combination.

The added amounts of the other components at the time of molding are not particularly limited as long as the effects of the present invention are not impaired, but the proportion of the added amounts of the other components with respect to the total amount of the blended components (that is, the total of the added amounts of the liquid crystalline polyester resin composition and other components) represented by the formula: [added amounts (parts by mass) of other components]/[total added amount (parts by mass) of the liquid crystalline polyester resin composition and other components]×100 is preferably 5% by mass or less, more preferably 3% by mass or less; still more preferably 1% by mass or less, and may even be 0% by mass. When the proportion of the added amounts of the other components is equal to or less than the upper limit value, the plasticizing time during molding of the liquid crystalline polyester resin composition becomes more stable.

The molding conditions of the liquid crystalline polyester resin composition are not particularly limited, and may be appropriately selected according to the molding method. For example, in the case of molding using an injection molding method, the cylinder temperature of the injection molding machine is preferably 300° C. or more and 400° C. or less, and the mold temperature is preferably 40° C. or more and 160° C. or less.

In the case of applying an injection molding method, for example, in an injection unit of an injection molding machine, plasticizing is carried out by melting the liquid crystalline polyester resin composition and measuring the resulting melt, and in a die unit of the injection molding machine, the melt is formed. At this time, by using the liquid crystalline polyester resin composition, since the measuring time (that is, plasticizing time) of the melt of the liquid crystalline polyester resin composition in the injection unit is stabilized with the fluctuation being suppressed, the plasticizing time is definitely shorter than the cooling time of the molded article in the die unit. Therefore, it can be easily molded in a fixed cycle, and high quality molded articles can be manufactured with high productivity. In the present specification, the plasticizing time can be obtained from the time for measuring the molten resin to be injected next in the injection molding machine.

At the time of injection molding, the standard deviation calculated from the measurement value of plasticizing time when plasticization of the liquid crystalline polyester resin composition is repeated 30 times can be set preferably to 0.01 or more and 1 or less, more preferably 0.01 or more and 0.9 or less, and can also be set to any one of, for example, 0.01 or more and 0.8 or less, 0.01 or more and 0.6 or less, and the like.

The molded article according to one embodiment of the present invention is suitable for use in molded articles that are required to have heat distortion resistance, such as electronic components, OA, AV components, heat resistant tableware and the like.

Examples of products and parts constituted by the molded article of the present invention include bobbins such as optical pickup bobbins and transformer bobbins; relay parts such as relay cases, relay bases, relay sprues and relay armatures; connectors such as RIMM, DDR, CPU sockets, S/O, DIMM, Board to Board connectors, FPC connectors and card connectors; reflectors such as lamp reflectors and LED reflectors; holders such as lamp holders and heater holders; diaphragms such as speaker diaphragms; separation claws such as separation claws for photocopiers and separation claws for printers; camera module parts; switch parts; motor parts; sensor parts; hard disk drive parts; eating utensils such as ovenware; vehicle parts; battery pans; aircraft pans; and sealing members such as semiconductor element sealing members and coil scaling members.

Another aspect of the present invention is

a liquid crystalline polyester resin composition including a liquid crystalline polyester, an amide compound, and if required, one or more substances selected from the group consisting of a filler and other components, wherein

the aforementioned liquid crystalline polyester includes a repeating unit represented by the formula (1), a repeating unit represented by the formula (2), and a repeating unit represented by the formula (3), and preferably includes a repeating unit derived from 4-hydroxybenzoic acid, a repeating unit derived from terephthalic acid, a repeating unit derived from isophthalic acid, and a repeating unit derived from 4,4′-dihydroxybiphenyl;

the aforementioned amide compound includes a structural unit derived from at least one compound selected from the group consisting of lauric acid, myristic acid, palmitic acid, stearic acid, behenic acid, and montanic acid.

a structural unit derived from at least one compound selected from the group consisting of ethylenediamine, 1,3-diaminopropane, hexamethylenediamine, undecamethylenediamine, and dodecamethylenediamine, and

a structural unit derived from at least one compound selected from the group consisting of adipic acid, sebacic acid, pimelic acid, and azelaic acid, and

preferably includes a structural unit derived from stearic acid, a structural unit derived from ethylenediamine, and a structural unit derived from sebacic acid;

the melting point of the aforementioned amide compound is 100° C. or higher, preferably 100° C. or higher and 300° C. or lower, and more preferably 200° C. or higher and 300° C. or lower;

the volume average particle diameter of the aforementioned amide compound is 5 μm or more and 50 μm or less, and preferably 5 μm or more and 35 μm or less, or may be 9 μm or more and 46 μm or less, and may be 9 μm or more and 28 μm or less;

the aforementioned tiller is at least one member selected from the group consisting of milled glass fibers, chopped strand glass fibers and talc;

the aforementioned other component is at least one member selected from the group consisting of an antioxidant, a thermal stabilizer, an ultraviolet absorber, an antistatic agent, a surfactant, a flame retardant, a colorant, and a resin other than the aforementioned liquid crystalline polyester;

the content of the aforementioned liquid crystalline polyester is from 55 to 65% by mass with respect to the total mass of the aforementioned liquid crystalline polyester resin composition; and

the content of the aforementioned amide compound is 0.005 parts by mass or more and less than 0.1 parts by mass, preferably 0.01 parts by mass or more and 0.08 parts by mass or less, and more preferably 0.02 parts by mass or more and 0.05 parts by mass or less, or may be 0.007 parts by mass or more and 0.08 pans by mass or less, and may be 0.03 parts by mass or more and 0.04 parts by mass or less, with respect to 100 parts by mass of the content of the aforementioned liquid crystalline polyester.

Yet another aspect of the present invention is

a liquid crystalline polyester pellet including a liquid crystalline polyester, an amide compound, and if required, one or more substances selected from the group consisting of a filler and other components, wherein

in the liquid crystalline polyester pellet, at least a part of the pellet containing the aforementioned liquid crystalline polyester is coated with an amide compound;

the aforementioned liquid crystalline polyester includes a repeating unit represented by the formula (1), a repeating unit represented by the formula (2), and a repeating unit represented by the formula (3), and preferably includes a repeating unit derived from 4-hydroxybenzoic acid, a repealing unit derived from terephthalic acid, a repeating unit derived from isophthalic acid, and a repeating unit derived from 4,4′-dihydroxybiphenyl;

the aforementioned amide compound includes:

a structural unit derived from at least one compound selected from the group consisting of lauric acid, myristic acid, palmitic acid, stearic acid, behenic acid, and montanic acid,

a structural unit derived from at least one compound selected from the group consisting of ethylenediamine, 1,3-diaminopropane, hexamethylenediamine, undecamethylenediamine, and dodecamethylenediamine, and

a structural unit derived from at least one compound selected from the group consisting of adipic acid, sebacic acid, pimelic acid, and azelaic acid, and

preferably includes a structural unit derived from stearic acid, a structural unit derived from ethylenediamine, and a structural unit derived from sebacic acid;

the melting point of the aforementioned amide compound is 100° C. or higher, preferably 100° C. or higher and 300° C. or lower, and more preferably 200° C. or higher and 300° C. or lower;

the volume average particle diameter of the aforementioned amide compound is 5 μm or more and 50 μm or less, and preferably 5 μm or more and 35 μm or less, or may be 9 μm or more and 46 μm or less, and may be 9 μm or more and 28 μm or less;

the aforementioned filler is at least one member selected from the group consisting of milled glass fibers, chopped strand glass fibers and talc;

the aforementioned other component is at least one member selected from the group consisting of an antioxidant, a thermal stabilizer, an ultraviolet absorber, an antistatic agent, a surfactant, a flame retardant, a colorant, and a resin other than the aforementioned liquid crystalline polyester;

the content of the aforementioned liquid crystalline polyester is from 55 to 65% by mass with respect to the total mass of the aforementioned liquid crystalline polyester pellet; and

the content of the aforementioned amide compound is 0.005 parts by mass or more and less than 0.1 parts by mass, preferably 0.01 parts by mass or more and 0.08 parts by mass or less, and more preferably 0.02 parts by mass or more and 0.05 parts by mass or less, or may be 0.007 parts by mass or more and 0.08 parts by mass or less, and may be 0.03 parts by mass or more and 0.04 parts by mass or less, with respect to 100 parts by mass of the content of the aforementioned liquid crystalline polyester.

### EXAMPLES

Hereinafter, the present invention will be described in more detail with reference to specific examples. However, the present invention is not limited in any way by the following examples.

It should be noted that in these examples and comparative examples, volume average particle diameters, melting points and pellet shapes were measured by the following methods, respectively.

### <Measurement Method of Volume Average Particle Diameter>

The volume average particle diameter was measured by a laser diffraction method under the following conditions.

Measurement Conditions

Measuring apparatus: laser diffraction/scattering type particle size distribution measuring apparatus (LA-950V2, manufactured by HORIBA, Ltd.)

Particle refractive index: 1.53-0.11

Dispersion medium: water

Dispersion medium refractive index: 1.33

### <Measurement Method of Melting Point>

The melting point was measured using a differential thermal analyzer (DTA-50, manufactured by Shimadzu Corporation). Using a 5 mg sample, the endothermic peak temperature observed when measured from room temperature to 400° C. under a condition of temperature increase of 20° C./win was taken as the melting point.

### <Measurement Method of Pellet Shape>

The lengths, long diameters and short diameters of pellets were measured using VHX 1000) manufactured by Keyence Corporation.

The parameters of the pellet, were 20, and the average value thereof was obtained.

Further, the main raw materials used in these examples and comparative examples are shown below.

[Fibrous filler B1]

B1-1: milled glass fiber, “PF70E-001” manufactured by Nitto Boseki Co., Ltd.

B1-2: chopped glass fiber, “CS03JAPX-1” manufactured by Owens Corning Corporation

### [Plate-Like Filler B2]

B2: talc, “X-50” manufactured by Nippon Talc Co., Ltd.

### [Amide Compound or Ester Compound C]

C1: Amide, compound C1-23 produced by the following method.

568 g of stearic acid and 66.8 g of sebacic acid were placed in a reactor and heated and dissolved, and then 83.5 g of ethylenediamine was gradually added thereto to start a dehydration reaction from 160° C. in a nitrogen stream, and the reaction was carried out at 250° C. for 5 hours until the amine value reached 5 mg KOH/g or less. Then, the resultant was poured into a vat and solidified, and pulverized by a pulverizer to thereby obtain a powdery amide compound C1. The amide compound C1 had a melting point of 210° C. and a volume average particle diameter of 23 μm (that is, the amide compound C1-23 was obtained).

The amine value can be measured by non-aqueous titration with perchloric acid according to the method Tf 2a-64 of the American Oil Chemist's Society, which is calculated as mg KOH per gram sample.

C2: amide compounds C2-9, C2-19, C2-28, C2-46 and C2-55 prepared by the following method.

568 g of stearic acid and 202 g of sebacic acid were placed in a reactor and heated and dissolved, and then 120 g of ethylenediamine was gradually added thereto to start a dehydration reaction from 160° C. in a nitrogen stream, and the reaction was carried out at 250° C. for 5 hours until the amine value reached 5 mg KOH/g or less. Then, the resultant was poured into a vat and solidified, and pulverized by a pulverizer to thereby obtain a powdery amide compound C2. The melting point of the amide compound C2 was 242° C.

The amide compound C2 obtained as described above was classified using sieves having openings of 25 μm, 63 μm and 75 μm to obtain an amide compound (amide compound C2-9), an amide compound (amide compound C2-19), an amide compound (amide compound C2-28), an amide compound (amide compound C2-46), and an amide compound (amide compound C2-55), which had a volume average particle diameter of 9 μm, 19 μm, 28 μm, 46 μm, and 55 μm, respectively. The relationship between the sieve used and the amide compound (powder) having the respective volume average particle diameters is as follows.

C2-55: a powder remained on the sieve with an opening of 75 μm.

C2-46: a powder which passed through the sieve with an opening of 75 μm and remained on the sieve with an opening of 63 μm.

C2-28: a powder which passed through the sieve with an opening of 63 μm and remained on the sieve with an opening of 25 μm.

C2-19: a powder obtained by classifying C2-28 once again, which passed through the sieve with an opening of 63 μm and remained on the sieve with an opening of 25 μm.

C2-9: a powder which passed through the sieve with an opening of 25 μm.

C3: fatty acid polyol ester “LOXIOL VPG 861 (trade name)” (melting point: 64° C., volume average particle diameter: 287 μm) manufactured by Emery Oleochemicals Japan Ltd.

C4: polyamide compound “VESTOSINT 2070 (trade name)” (melting point: 182° C., volume average particle diameter: 9 μm) manufactured by Daicel-Degussa Ltd. It should be noted that in the present specification, the polyamide compound refers to a polyamide resin obtained by ring-opening polymerization of laurolactam.

C5: Amide compounds C5-15 and C5-135 produced by the following method.

568 g of stearic acid was placed in a reactor and heated and dissolved, and then 60 g of ethylenediamine was gradually added thereto to start a dehydration reaction from 160° C. in a nitrogen stream, and the reaction was carried out at 250° C. for 5 hours until the amine value reached 5 mg KOH/g or less. Then, the resultant was poured into a vat and solidified, and pulverized by a pulverizer to thereby obtain a powdery amide compound C5. The melting point was 146° C.

Furthermore, the amide compound C5 obtained as described above was classified using a sieve having an opening of 63 μm to obtain an amide compound (amide compound C5-15) and an amide compound (amide compound C5-135), which had a volume average particle diameter of 15 μm and 135 μm, respectively.

### <Production of Liquid Crystalline Polyester>

### Production Example 1

p-hydroxybenzoic acid (994.5 g, 7.20 mol), terephthalic acid (272.1 g, 1.64 mol), isophthalic acid (126.6 g, 0.76 mol), 4,4′-dihydroxybiphenyl (446.9 g, 2.40 mol) and 1347.6 g (13.20 mol) of acetic anhydride were charged into a reactor equipped with a stirrer, a torque meter, a nitrogen gas inlet tube, a thermometer and a reflux condenser. After replacing the gas in the reactor with nitrogen gas, 0.18 g of 1-methylimidazole was added, and the temperature was raised from room temperature to 150° C. over 30 minutes while stirring under a nitrogen gas stream to reflux at 150° C. for 30 minutes.

Subsequently, after adding 2.4 g of 1-methylimidazole, the temperature was raised from 150° C. to 320° C. over 2 hours and 50 minutes while distilling off acetic acid generated as a by-product and unreacted acetic anhydride, and the reaction was terminated at a time point where an increase in torque was observed. The contents were taken out from the reactor and cooled to room temperature to obtain a prepolymer (solid).

Subsequently, the prepolymer was pulverized using a pulverizer, and the obtained pulverized material was subjected to solid phase polymerization by raising the temperature from room temperature to 250° C. over 1 hour in a nitrogen gas atmosphere, raising the temperature from 250° C. to 280° C. over 5 hours and maintaining the temperature at 280° C. for 3 hours. The obtained solid phase polymer material was cooled to room temperature to obtain a liquid crystalline polyester A1. The flow starting temperature of the obtained liquid crystalline polyester A1 was 312° C.

### Production Example 2

p-hydroxybenzoic acid (994.5 g, 7.20 mol), terephthalic acid (299.0 g, 1.80 mol), isophthalic acid (99.7 g, 0.60 mol), 4,4′-dihydroxybiphenyl (446.9 g, 2.40 mol) and acetic anhydride (1347.6 g, 13.20 mol) were placed in a reactor equipped with a stirrer, a torque meter, a nitrogen gas inlet tube, a thermometer and a reflux condenser. After replacing the gas in the reactor with nitrogen gas, 0.18 g of 1-methylimidazole was added, and the temperature was raised from room temperature to 150° C. over 30 minutes while stirring under a nitrogen gas stream to reflux at 150° C. for 1 hour.

Subsequently, after adding 2.4 g of 1-methylimidazole, the temperature was raised from 150° C. to 320° C. over 2 hours and 50 minutes while distilling off acetic acid generated as a by-product and unreacted acetic anhydride, and the reaction was terminated at a time point where an increase in torque was observed. The contents were taken out from the reactor and cooled to room temperature to obtain a prepolymer (solid).

Subsequently, the prepolymer was pulverized using a pulverizer, and the obtained pulverized material was subjected to solid phase polymerization by raising the temperature from room temperature to 250° C. over 1 hour in a nitrogen gas atmosphere, raising the temperature from 250° C. to 285° C. over 5 hours and maintaining the temperature at 285° C. for 3 hours. The obtained solid phase polymer material was cooled to room temperature to obtain a liquid crystalline polyester A2. The flow starting temperature of the obtained Liquid crystalline polyester A2 was 327° C.

### Examples 1 to 10, Comparative Examples 1 to 9

### <Production of Liquid Crystalline Polyester Resin Composition>

To a twin screw extruder (“PCM-30 model”, manufactured by Ikegai Ironworks Corp) with a cylinder temperature set at 340° C., the liquid crystalline polyester A1 or A2 in an amount shown in Table 1 and the fibrous filler B1 and plate-like filler B2 in amounts shown in Table 1 were supplied together from a raw material supply port thereof and melt kneaded in a condition of a screw rotation frequency of 150 rpm, and the kneaded product was discharged in the form of a strand via a circular nozzle (discharge port) having a diameter of 3 mm. Subsequently, the discharged kneaded product was dipped in a water bath with a water temperature of 30° C. for 1.5 seconds, and then passed through a take-off roller under a condition of a take-off speed of 40 m/min and pelletized using a strand cutter (manufactured by Tanabe Plastics Machinery Co., Ltd.) whose rotary blade was adjusted to 60 m/min to obtain a pellet (intermediate composition pellet) containing a liquid crystalline polyester. As a result of pellet shape measurement, the pellet had a length of 2.6 mm, a long diameter of 2.1 mint and a short diameter of 1.8 mm.

Subsequently, an amide compound or ester compound C of a type and amount shown in Table 1 was mixed in a solid state with 100 parts by mass of the obtained pellet. At that time, the temperature of the pellet measured with a radiation thermometer was 180° C. After mixing the amide compound or ester compound C, the resulting mixture was further mixed using a tumbler mixer to obtain a liquid crystalline polyester resin composition (liquid crystalline polyester pellet) in which the surface of the pellet is coated with the amide compound. The liquid crystalline polyester resin compositions obtained in Examples 1 to 10 contain an amide compound having the same volume average particle diameter as that of the amide compound mixed in a powder form.

It should be noted that the description “−” in the section of blended components in Table 1 means that the component is not blended.

### <Production of Molded Article>

With respect to the obtained liquid crystalline polyester resin composition, measuring time (plasticizing time) during continuous molding of 30 shots under the following conditions was measured using an injection molding machine (“ES400-5E” manufactured by Nissei Plastic Industrial Co., Ltd.), and the average value and standard deviation thereof were determined.

### (Molding Conditions)

Cylinder temperature (° C.) 350-350-350-310

Mold temperature (° C.): 130

Measurement (mm): 54

Suck back (mm): 2

Screw rotation frequency (rpm): 175

Back pressure (MPa): 4

Molded product shape: specular specimen (length: 64 mm, width: 64 mm, thickness: 3 mm)

### <Evaluation of Measurement Stability>

From the standard deviation or average value of the measuring time of the liquid crystalline polyester resin composition obtained at the time of injection molding as described above, measurement stability was evaluated according to the following criteria. The respective measuring times, the standard deviations and average values thereof, and the evaluation results are shown in Table 2.

It should be noted that the description “−” in the section of evaluation results in Table 2 means that the results therein were not evaluated.

a: The standard deviation is 0.3 or less, and the measurement stability is particularly high.

b: The standard deviation is greater than 0.3 and 1 or less, and the measurement stability is high.

c: The standard deviation is greater than 1 or the measuring time is 20 seconds or more, and the measurement stability is poor.

### <Evaluation of Detachability of Amide Compound or Ester Compound C>

The detachability of the amide compound or ester compound C was evaluated by the following method.

That is, 500 g of the obtained liquid crystalline polyester resin composition (liquid crystalline polyester pellet) was sieved for 1 minute using a sieve having an opening of 1 mm, and the detached amide compound or ester compound C was collected and the weight thereof (including a powder of the liquid crystalline polyester itself) was measured. The detachability of the amide compound or ester compound C coating the surface of the pellet was evaluated according to the following criteria. The evaluation results are shown in Table 2.

a: The weight of the detached amide compound or ester compound C is less than 0.1 g.

b: The weight of the detached amide compound or ester compound C is 0.1 g or more.

TABLE 1

| | | | Filler | | | | | |
|---|---|---|---|---|---|---|---|---|
| | Liquid crystalline | | Fibrous | | Plate-like | | Amide compound or | |
| | polyester A | | filler B1 | | filler B2 | | ester compound C | |
| | | Amount | | Amount | | Amount | | Amount |
| | | (parts by | | (parts by | | (parts by | | (parts by |
| | Type | mass) | Type | mass) | Type | mass) | Type | mass) |
| Ex. 1 | A1 | 100 | B1-1 | 16.7 | B2 | 50.0 | C1-23 | 0.03 |
| Ex. 2 | A1 | 100 | B1-1 | 16.7 | B2 | 50.0 | C2-9 | 0.04 |
| Ex. 3 | A1 | 100 | B1-1 | 16.7 | B2 | 50.0 | C2-19 | 0.04 |
| Ex. 4 | A1 | 100 | B1-1 | 16.7 | B2 | 50.0 | C2-28 | 0.03 |
| Ex. 5 | A1 | 100 | B1-1 | 16.7 | B2 | 50.0 | C2-28 | 0.04 |
| Ex. 6 | A1 | 100 | B1-1 | 16.7 | B2 | 50.0 | C2-28 | 0.05 |
| Ex. 7 | A2 | 100 | B1-2 | 50.0 | B2 | 16.7 | C2-28 | 0.03 |
| Ex. 8 | A1 | 100 | B1-1 | 16.7 | B2 | 50.0 | C2-28 | 0.007 |
| Ex. 9 | A1 | 100 | B1-1 | 16.7 | B2 | 50.0 | C2-28 | 0.08 |
| Ex. 10 | A1 | 100 | B1-1 | 16.7 | B2 | 50.0 | C2-46 | 0.04 |
| Comp. Ex. 1 | A1 | 100 | B1-1 | 16.7 | B2 | 50.0 | — | — |
| Comp. Ex. 2 | A1 | 100 | B1-1 | 16.7 | B2 | 50.0 | C2-28 | 0.001 |
| Comp. Ex. 3 | A1 | 100 | B1-1 | 16.7 | B2 | 50.0 | C2-28 | 0.15 |
| Comp. Ex. 4 | A1 | 100 | B1-1 | 16.7 | B2 | 50.0 | C2-28 | 5.00 |
| Comp. Ex. 5 | A1 | 100 | B1-1 | 16.7 | B2 | 50.0 | C2-55 | 0.04 |
| Comp. Ex. 6 | A1 | 100 | B1-1 | 16.7 | B2 | 50.0 | C3 | 0.04 |
| Comp. Ex. 7 | A1 | 100 | B1-1 | 16.7 | B2 | 50.0 | C4 | 0.03 |
| Comp. Ex. 8 | A1 | 100 | B1-1 | 16.7 | B2 | 50.0 | C5-15 | 0.04 |
| Comp. Ex. 9 | A1 | 100 | B1-1 | 16.7 | B2 | 50.0 | C5-135 | 0.04 |

TABLE 2

| | | | | Detachability of | |
|---|---|---|---|---|---|
| | Measurement stability | | | amide compound or | |
| | Average value | Standard | | ester compound C | |
| | of measur- | deviation | Evalu- | Detached | Evalu- |
| | ing time | of measur- | ation | amount | ation |
| | (sec) | ing time | results | (g) | results |
| Ex. 1 | 16.8 | 0.4 | b | 0.04 | a |
| Ex. 2 | 10.2 | 0.3 | a | 0.04 | a |
| Ex. 3 | 10.1 | 0.3 | a | 0.02 | a |
| Ex. 4 | 8.5 | 0.2 | a | 0.02 | a |
| Ex. 5 | 8.6 | 0.2 | a | 0.05 | a |
| Ex. 6 | 10.5 | 0.4 | b | 0.03 | a |
| Ex. 7 | 14.0 | 0.2 | a | 0.02 | a |
| Ex. 8 | 15.7 | 0.9 | b | 0 | a |
| Ex. 9 | 13.9 | 0.4 | b | 0.05 | a |
| Ex. 10 | 9.7 | 0.4 | b | 0.05 | a |
| Comp. Ex. 1 | 15.8 | 9.4 | c | 0 | a |
| Comp. Ex. 2 | 23.7 | 5.5 | c | 0 | a |
| Comp. Ex. 3 | 19.1 | 0.3 | a | 0.12 | b |
| Comp. Ex. 4 | 14.8 | 7.0 | c | 15.02 | b |
| Comp. Ex. 5 | 20.3 | 5.0 | c | 0.05 | a |
| Comp. Ex. 6 | 31.8 | 3.2 | c | 0.13 | b |
| Comp. Ex. 7 | 12.8 | 2.0 | c | 0.01 | a |
| Comp. Ex. 8 | 25.3 | 0.9 | c | 0.06 | a |
| Comp. Ex. 9 | 27.1 | 2.2 | c | 0.12 | b |

It is apparent from Table 2 that as compared with the liquid crystalline polyester resin compositions of Comparative Examples 1 to 9, the liquid crystalline polyester resin compositions of Examples 1 to 10 are superior in measurement stability, stable in the molding process, and also improves the detachability of the amide compound.

### INDUSTRIAL APPLICABILITY

The liquid crystalline polyester resin composition of the present invention is extremely useful industrially because it can be used for molded articles that are required to have heat distortion resistance, such as electronic components, OA, AV components, heat resistant tableware and the like.

1. A liquid crystalline polyester resin composition comprising:
a liquid crystalline polyester; and
an amide compound including the following structural units (I) to (III), and having a melting point of 100° C. or higher and a volume average particle diameter of 5 μm or more and 50 μm or less,
wherein a content of said amide compound is 0.005 parts by mass or more and less than 0.1 parts by mass with respect to 100 parts by mass of a content of said liquid crystalline polyester,
structural unit (I): CH₃—X—CO—,
wherein X represents an aliphatic hydrocarbon group having 10 or more carbon atoms or a hydroxy hydrocarbon group in which one or more hydrogen atoms of an aliphatic hydrocarbon group are substituted with a hydroxy group;
structural unit (II): —HN—Y—NH—,
wherein Y represents a hydrocarbon group having 2 or more carbon atoms;
structural unit (III): —OC—Z—CO—,
wherein Z represents an aliphatic hydrocarbon group having 4 or more carbon atoms, an alicyclic hydrocarbon group, or an aromatic hydrocarbon group.

2. The liquid crystalline polyester resin composition according to claim 1, wherein the structural unit (I) in said amide compound is a structural unit represented by the following formula (I)′,
CH₃—(CH₂)ₗ—CO—, (I)′:
l represents an integer of 10 or more.

3. The liquid crystalline polyester resin composition according to claim 1, wherein the structural unit (II) in said amide compound is a structural unit represented by the following formula (II)′,
—HN—(CH₂)ₘ—NH—, (II)′:
m represents an integer of 2 to 12.

4. The liquid crystalline polyester resin composition according to claim 1, wherein the structural unit (III) in said amide compound is a structural unit represented by the following formula (III)′,
—OC—(CH₂)ₙ—CO—, (III)′:
n represents an integer of 4 to 12.

5. The liquid crystalline polyester resin composition according to claim 1, wherein a content of said amide compound is 0.02 parts by mass or more and 0.05 parts by mass or less with respect to 100 parts by mass of a content of the liquid crystalline polyester.

6. The liquid crystalline polyester resin composition according to claim 1, wherein said amide compound comprises 1 to 30 mol % of the structural unit (III) with respect to a total amount of the structural unit (I), the structural unit (II), and the structural unit (III).

7. The liquid crystalline polyester resin composition according to claim 1, wherein said liquid crystalline polyester comprises a repeating unit derived from an aromatic hydroxycarboxylic acid, a repeating unit derived from an aromatic dicarboxylic acid, and a repeating unit derived from an aromatic diol, an aromatic hydroxyamine or an aromatic diamine.

8. A liquid crystalline polyester pellet wherein at least a part of a surface of a pellet containing a liquid crystalline polyester is coated with an amide compound,
said amide compound comprises the following structural units (I) to (III), and has a melting point of 100° C. or higher and a volume average particle diameter of 5 μm or more and 50 μm or less; and
a content of said amide compound is 0.005 parts by mass or more and less than 0.1 parts by mass with respect to 100 parts by mass of a content of said liquid crystalline polyester,
structural unit (I): CH₃—X—CO—,
X represents an aliphatic hydrocarbon group having 10 or more carbon atoms or a hydroxy hydrocarbon group in which one or more hydrogen atoms of an aliphatic hydrocarbon group are substituted with a hydroxy group;
structural unit (II): —HN—Y—NH—,
Y represents a hydrocarbon group having 2 or more carbon atoms;
structural unit (III): —OC—Z—CO—,
Z represents an aliphatic hydrocarbon group having 4 or more carbon atoms, an alicyclic hydrocarbon group, or an aromatic hydrocarbon group.

9. An injection molded article formed from the liquid crystalline polyester resin composition according to claim 1.

10. A method for producing a liquid crystalline polyester resin composition,
the method comprising mixing a pellet containing a liquid crystalline polyester and an amide compound including the following structural units (I) to (III) and having a melting point of 100° C. or higher and a volume average particle diameter of 5 μm or more and 50 μm or less,
so that a mixing amount of said amide compound is 0.005 parts by mass or more and less than 0.1 parts by mass, when a mixing amount of said liquid crystalline polyester is 100 parts by mass,
structural unit (I): CH₃—X—CO—,
X represents an aliphatic hydrocarbon group having 10 or more carbon atoms or a hydroxy hydrocarbon group in which one or more hydrogen atoms of an aliphatic hydrocarbon group are substituted with a hydroxy group;
structural unit (II): —HN—Y—NH—,
Y represents a hydrocarbon group having 2 or more carbon atoms;
structural unit (III): —OC—Z—CO—,
Z represents an aliphatic hydrocarbon group having 4 or more carbon atoms, an alicyclic hydrocarbon group, or an aromatic hydrocarbon group.

11. An amide compound comprising the following structural units (I) to (III), and having a melting point of 100° C. or higher and a volume average particle diameter of 5 μm or more and 50 μm or less,
structural unit (I): CH₃—X—CO—,
X represents an aliphatic hydrocarbon group having 10 or more carbon atoms or a hydroxy hydrocarbon group in which one or more hydrogen atoms of an aliphatic hydrocarbon group are substituted with a hydroxy group;
structural unit (II): —HN—Y—NH—,
Y represents a hydrocarbon group having 2 or more carbon atoms;
structural unit (III): —OC—Z—CO—,
Z represents an aliphatic hydrocarbon group having 4 or more carbon atoms, an alicyclic hydrocarbon group, or an aromatic hydrocarbon group.

12. An injection molded article formed from the liquid crystalline polyester pellet according to claim 8.
